(19) United States
(12) Patent Application Publication
(10) Pub. No.: US 2005/0165704 A1
(43) Pub. Date: Jul. 28, 2005

(54) Method and apparatus for merging of bulk mailings

(75) Inventors: Steven W. Lopez, Colorado Springs, CO (US); Thomas Roche, Ashburn, VA (US)

Correspondence Address: AKERMAN SENTERFITT, P.O. BOX 3188, WEST PALM BEACH, FL, 33402-3188, US

(73) Assignee: Technology Solutions International, Inc., Melbourne, FL (US)

(21) Appl. No.: 11/044,911

(22) Filed: Jan. 27, 2005

Related U.S. Application Data
(60) Provisional application No. 60/539,704, filed on Jan. 28, 2004.

(51) Int. Cl. G06F 17/60

(52) U.S. Cl. 705/410

(57) ABSTRACT

The present invention provides an improved and simplified method for preparing and merging mailings from two or more separate mailings. The method includes evaluating a plurality of bundles of mailings, and merging one or more of the bundles of mailings into at least one merged mailing. Each of the plurality of bundles of mailings is evaluated in regards to at least one evaluation characteristic to determine an optimal combination of bundles of mailings such that the merged mailing has an optimal value for the at least one evaluation characteristic. This method uses low cost equipment with a simplified process to combine multiple batches of mail to a single mailing onto pallets in a manner that provides for easy postal service verification of postage required. The primary benefit is a method to achieve the lowest cost when mailer preparation, copalletization, transportation and postage costs are considered.

### CROSS REFERENCE TO RELATED APPLICATIONS

The present invention claims priority to U.S. Provisional Patent Application No. 60/539,704, filed Jan. 28, 2004, the entire contents of which is incorporated herein by reference.

### FIELD OF THE INVENTION

The invention relates to a method and apparatus for preparing a merged bulk mailing from multiple bulk mailings in a manner consistent with the United States Postal Service (“USPS”) or other postal service requirements, and particularly to a simplified and low-cost method for merging bulk mailings.

### BACKGROUND OF THE INVENTION

The U.S. Postal Service has put in place a set of regulations that govern the preparation of bulk mailings, which may be composed, for example, of magazines, journals, advertisements and/or other mail items. These regulations are published in the Domestic Mail Manual (DMM). In the past, bulk mailing regulations have required that bulk mailings be prepared with a single size, shape and weight of individual pieces that are then combined into bundles for a specific geographic area. Such bundles are then combined with other bundles into a container. A bundle is typically defined as a bundle of multiple single pieces, which may be strapped or wrapped together with plastic wrap. The two types of containers typically used for bulk mailing bundles are sacks and pallets. Pallets are required to have at least 250 pounds of mail, whereas the required container for less than 250 pounds is typically a sack. Sacks must be handled and sorted more often than pallets, and consequently the wrapping around the bundles sorted into sacks tends to break during such handling.

Recently, the USPS has developed regulations that allow combining multiple mailings of different size, shape and weight into one bulk mailing consisting of pallet containers. These rules allow combining multiple mailings that typically would have to be placed in sacks because of low volume. In a combined mailing, there should be sufficient volume to qualify as palletized mailings under postal service rules. It is desirable, in addition to reducing mailing costs by combining more bundles into pallets, to reduce the wrapping required for bundles to withstand the heavy handling of sacks, as the use of the plastic wrap is both expensive and undesirable environmentally.

The benefit to mailers for combining multiple mailings is in lower postage rates and transportation costs. The benefit for the postal service is to reduce sacked mail, a very labor intensive and damage prone method for mailing. The USPS has a very complicated set of rules that govern the preparation requirements and postage rates for bulk mailings. These rules provide varying levels of mailing rates based on depth of sort, volume, point of entry, and type of container or bundle.

The depth of sort is the geographic area that a mailer is required to sort to, which is based upon the amount of mail volume for that area. As used herein, a “mailer” is a person or company that sends mail. The depth of sort area may be described as a carrier route, a 5-digit ZIP code area, a 3-digit ZIP area also known as a Sectional Center Facility (SCF), an Area Distribution Facility (ADC) composed of multiple 3 digit zip codes, a Bulk Mail Center (BMC) composed of multiple ADC's and SCF's, and residual mail representing geographic areas that do not have sufficient volume for one the above containers.

In the U.S. Postal Service, there are over 250,000 carrier routes, over 40,000 unique 5 digit zip codes, over 450 SCF facilities, over 100 ADC facilities, and over 20 BMC's. It is easy to understand that typical sorting equipment would have to be extremely large and complex.

Containers are made up of one or more bundles, each of which is a bundle of mail items representing a carrier route, a 5-digit ZIP code, or a 3-digit ZIP area. Bundles must typically have at least 6 or 10 pieces, and must be no more than 20 pounds in weight. Carrier route bundles have lower piece rate postage than 5-digit mail, which in turn is lower than the 3-digit postage rates. Pieces with insufficient volume for any type of bundle are residual volume which receives no discount.

The USPS additionally provides postage discounts based on where a container is submitted for mailing. Pallets submitted for mailing at the postal facility representing the depth of sort receive postage discounts. For example, a 5-digit pallet introduced at the delivery unit representing a particular 5-digit ZIP code will receive a larger discount than a pallet introduced at an ADC, which in turn receives a larger discount than a BMC pallet. Residual volume receives no discount.

Mail bundled on pallets receives a larger discount than mail bundled in sacks because of the more efficient postal handling associated with pallets. The process of copalletization as outlined in the DMM (specifically outlined in section M940) provides additional discounts that provide incentives for mailers to merge multiple mailings.

Preparing very large bulk mailings that do not have postage affixed to each individual piece is a very common practice in the mailing industry. The USPS has very stringent standards for mailer documentation and postal service verification of these mailings to ensure that correct postage is paid for each mailing. This documentation standard is currently embodied in the mail.dat specification that produces a set of files that is provided in electronic format and details each piece, bundle, container and supporting information for a specific mailing.

The process for mailers to merge bundles from various mailings has typically involved the use of a bundle sorter. Bundle sorters that provide the depth of sort necessary are very large, heavy duty equipment that is expensive to buy, operate and maintain. This high cost, coupled with the relatively small discount compared with the difficult process of combining large amounts of volume, both bundles and weight, have limited the ability of mailers to participate in postal service copalletization programs.

Another limitation of traditional sorting equipment is the limited depth of sort available with traditional equipment. A traditional mechanical sorter may have 100 separations. With over 450 SCF's, 103 ADC's and 21 BMC's, it is easy to understand that traditional equipment would have very limited ability to co-palletize without limiting the depth of sort thereby limiting the discounts or requiring multiple passes of bundles which would increase the labor costs and potential damage.

Mailers have developed sophisticated software for generating mailings at the lowest postage cost based on the rules the USPS has developed. Many algorithms have been developed to arrive at the lowest postage cost given the various container and bundle combinations available. These methods may minimize the postage costs without considering the preparation costs or the transportation costs. The present invention attempts to optimize one or more of costs associated with bulk mailings including, but not limited to, mailer preparation costs, copalletization labor costs, transportation costs and/or postage costs.

U.S. Patent Application Publication 2002/0069186 describes an attempt to determine the best bundle configuration by a specific mailer. It is an object of the present invention to determine the lowest cost for multiple mailings that may not qualify for any substantial postal discounts on their own.

### SUMMARY OF THE INVENTION

The present invention describes a simplified and/or low cost method for combining multiple bulk mailings into one consolidated mailing. The present invention can provide a method for combining multiple mailings into one that has a low initial cost for equipment, does not consume as much space as a traditional mechanical bundle sorter, and/or does not require substantial maintenance due to its simplicity. The present invention can provide tools that evaluate the labor and material costs together with transportation and postage costs to arrive at the lowest combined cost for bulk mailings.

The method of the invention can include evaluating a plurality of bundles of mailings, and merging one or more of the bundles of mailings into at least one merged mailing. Each of the plurality of bundles of mailings can be evaluated in regards to at least one evaluation characteristic to determine an optimal combination of bundles of mailings such that the merged mailing has an optimal value for the at least one evaluation characteristic.

The present invention is clearly distinct from prior systems in that it is primarily focused on minimizing costs after bundles have been prepared by the originating mailer. The present invention can evaluate many of the same parameters as prior art, however, this invention requires mailers to prepare small or unqualified mailings in a specific sequence and then prepare documentation indicating the sequence to supplement the mail.dat files required for postal documentation and verification. Mailers who participate in the unique preparation will presumably benefit in the form of lower shared costs.

The apparatus for determining an optimum merged mailing can include means for evaluating a plurality of bundles of mailings, and means for merging one or more of the bundles of mailings into at least one merged mailing. Each of the plurality of bundles of mailings can be evaluated in regards to at least one evaluation characteristic to determine an optimal combination of bundles of mailings such that the merged mailing has an optimal value for the at least one evaluation characteristic.

The physical apparatus for merging the bundles may be a known low cost powered conveyor and readily available from multiple vendors that are well known in the industry. Most conveyor type solutions for this type of function rely upon a large number of sorts to provide the primary benefit. The unique function of this conveyor that differentiates it from other conveyors is the limited sorting and the focus instead on a merge function.

The present invention can be scalable depending on the number of mailings that are to be merged together and is only limited by the number of mailings to be merged and the physical space available. Additional throughput or volume is easily achieved by adding additional conveyor systems that process different ranges of ZIP codes to be merged.

The sequence may be typically defined as ZIP code sequence with individual groupings of carrier route bundles first, followed by 5-digit bundles, followed further by 3-digit bundles although any number of predefined sequences could be employed as mailer needs and postal regulations may require.

The present invention can provide one or more of the following advantages and/or features. The present invention can provide a method and apparatus that allows mailers to evaluate merged mailings that will achieve the lowest combined cost of mailer preparation, copalletization or merging, transportation and postage. In another embodiment, the present invention can provide a method and apparatus that allows mailers to merge multiple mailings with sequenced bundles into one mailing of sequenced bundles using manual or automatic systems with the required documentation for Postal verification. In yet another embodiment, the present invention can provide an apparatus that merges bundles from multiple mailings prepared in a specific sequence into one primary mailing using manual or automatic systems with non-qualifying mail being diverted to a secondary location.

In still another embodiment, the present invention can provide a system whereby the electronic product of the merged mailing is a new mailing make-up file (such as mail.dat files, a database file, an XML document or any other electronically generated and formatted file) that accurately describes the new mailing and containers. In another embodiment, the present invention can provide a system whereby a mailing make-up file (such as mail.dat files, a database file, an XML document or any other electronically generated and formatted file) for each of the multiple mailings are interfaced with a container sequence file that identifies the physical sequence of all bundles in the container (i.e. pallet or sack) described in each mailing make-up file (such as mail.dat files, a database file, an XML document or any other electronically generated and formatted file). In yet another embodiment, the present invention can provide a software method for creating and formatting container sequence information and files using computer or electronic media. In still another embodiment, the present invention can provide a software method for updating or merging container sequence information or files to produce a container sequence file representative of the merged mailing. In a further embodiment, the present invention can provide a software method working together with mailer mailing make-up files (such as mail.dat files, a database file, an XML document or any other electronically generated and formatted file) for identifying the sequence of bundles on a mailer pallet that may be used for tracking the bundles offloaded from a pallet or the bundles to be loaded onto a merged pallet.

In another embodiment, the present invention can provide a process whereby the merged mailing make-up file (such as mail.dat files, a database file, an XML document or any other electronically generated and formatted file) is evaluated and adjusted to ensure optimum postage discounts as a result of the merged mailing. In yet another embodiment, the present invention can provide a system that interfaces the mailing make-up file (such as mail.dat files, a database file, an XML document or any other electronically generated and formatted file) for each mailing with the merging apparatus for the purpose of sorting and verification of individual bundles. In still another embodiment, the present invention can provide a system whereby mail categories not meeting minimum requirements for volume or weight may be separated from the merged mailing both physically and electronically with its own unique mailing make-up file (such as mail.dat files, a database file, an XML document or any other electronically generated and formatted file) that will allow for subsequent merging into a future mailing or sorting into smaller containers for immediate postal entry. In yet another embodiment, the present invention can provide an apparatus for separating layers of bundles with a separation sheet to ensure the container or pallet sequence is maintained for all levels.

In another embodiment, the present invention can provide an apparatus for separating and stacking pallets with the use of a collapsible, heavy duty, skirt that is re-usable and typically made out of cardboard. In still another embodiment, the present invention can provide an apparatus for transporting and conveying individual bundles from an individual mailing, in sequence, to the location where all bundles are merged together on a single transport for purposes of loading onto a merged pallet or residual bundle container. In yet another embodiment, the present invention can provide an apparatus for scanning, counting and/or weighing bundles as they are inducted from the container or pallet in sequence and matching against the mailing make-up file (such as mail.dat files, a database file, an XML document or any other electronically generated and formatted file) for accuracy. In another embodiment, the present invention can provide an apparatus for scanning, counting and/or weighing bundles and matching against the merged mailing make-up file (such as mail.dat files, a database file, an XML document or any other electronically generated and formatted file) for accuracy as they are placed on the merged copallet or container from the conveyor. In still another embodiment, the present invention provides an apparatus for individual bundle tracking on the conveyor with photocell or zone control. In another embodiment, the present invention can provide a software method for individual bundle tracking on the conveyor with photocell or zone control. In yet another embodiment, the present invention provides a process that uses proprietary data together with a software algorithm that will compare transportation costs together with postal container discounts and destination entry discounts thereby providing the lowest cost consideration.

### BRIEF DESCRIPTION OF THE DRAWINGS

Some of the features, advantages, and benefits of the present invention having been stated, others will become apparent as the description proceeds when taken in conjunction with the accompanying drawings in which:

FIG. 1 is a flow chart of cost optimization as it relates to the present invention;

FIG. 2 is a flow chart of a mail.dat file and interface with sequence files as it relates to the present invention;

FIG. 3 is a schematic drawing showing typical equipment layout as it relates to the present invention;

FIG. 4 is a schematic drawing showing typical physical mail flow as it relates to the present invention; and

FIG. 5 is a schematic drawing of typical sequenced pallet with bundles as it relates to the present invention.

### DETAILED DESCRIPTION OF THE PREFERRED EMBODIMENT

The present invention is more particularly described in the following description and examples that are intended to be illustrative only since numerous modifications and variations therein will be apparent to those skilled in the art. As used in the specification and in the claims, the singular form “a,” “an,” and “the” may include plural referents unless the context clearly dictates otherwise. Also, as used in the specification and in the claims, the term “comprising” may include the embodiments “consisting of” and “consisting essentially of.”

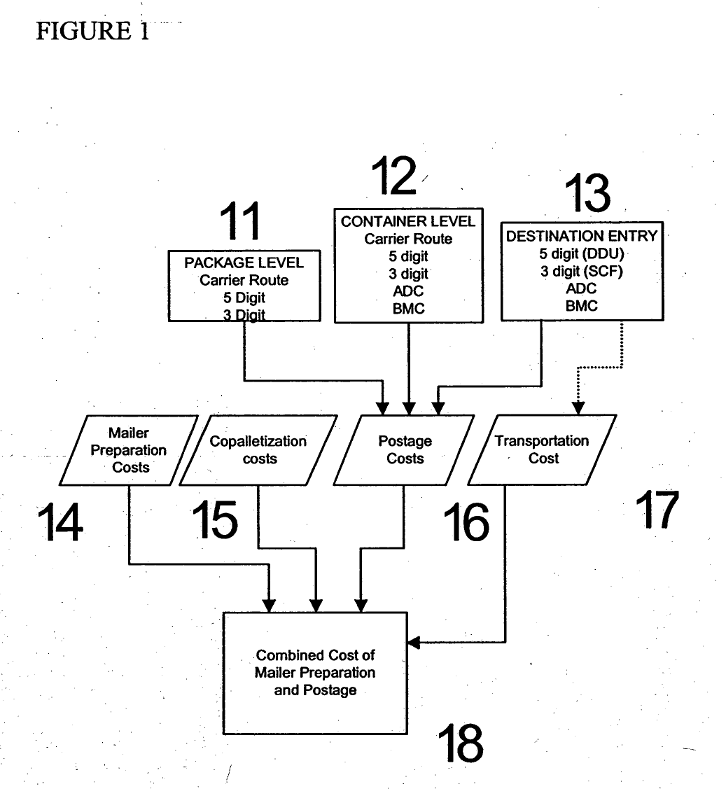

FIG. 1 illustrates issues to be evaluated regarding component costs that are involved in the merging of separate mailings.

A bundle level discount 11 is primarily determined by mailers prior to introduction to copalletization. Item 11 in FIG. 1 illustrates the three different types of bundles that are commonly submitted and for which discounts may be provided in current postal regulations. Such bundles include the several types of carrier route bundles, 5-digit bundles which may contain multiple 5-digit ZIP codes, and the 3-digit bundles which also may contain multiple 3-digit ZIP areas.

A container level discount 12 is a pallet or sack that contains one or more bundles. The designation of the container indicates the type of facility that the container typically is opened in, and the bundles are worked to smaller geographic areas. The smaller geographic area typically requires less work from the Postal personnel and therefore is given a greater postage discount.

A destination entry discount 13 is a process whereby the postage discount is greater for mail that is introduced as close to the geographic delivery point as is possible. Introduction of mail closer to the geographic delivery point generally requires the Postal Service to spend less on transporting this mail. Therefore, postage discounts and mailer savings are greater.

Mailer preparation costs 14 involve a large number of components that are typically mailer specific and sometimes mailing specific. Typical variables include, but are not limited to, the cost of labor to prepare bundles, the cost of placing bundles into containers, sacks or pallets, the number of bundles in a particular container, the cost of wrapping, strapping, and other packaging materials to protect the contents of bundles and containers, the cost of handling containers and the cost of administrative items such as facilities, data processing and/or supervision.

Copalletization costs 15 are a function of labor, facilities, administration, and equipment costs to assemble multiple mailings into one mailing. Typically, the costs of labor are a function of how efficient the equipment is and the cost of equipment includes the amortized initial cost together with the ongoing cost of maintenance.

The postage charges 16 that are payable to the Postal Service are a function of one or more of the bundle level discount 11, the container level discount 12, and the destination entry discount 13. In this invention, the copalletization process can primarily affect the container level discount 12 and the destination entry discount 13, which can thus reduce the overall postage charges payable.

Transportation costs 17 are a function of one or more of distance and volume. Typically, a truck transporting a unit load over varying distances can be described as a linear relationship; however, this relationship may be altered by one or more additional variables including, but not limited to, the size of the load, the number of stops along the way, the amount of deviation required to perform the stops and/or the volume of each stop.

The total of items 11 through 17 (the various discount levels 11-13 leading to the postage charges 16, the mailer preparation costs 14, the copalletization costs 15 and the transportation costs 17) can be factored together to arrive at a combined cost of a copalletized mailing, 18, which the present invention seeks to minimize.

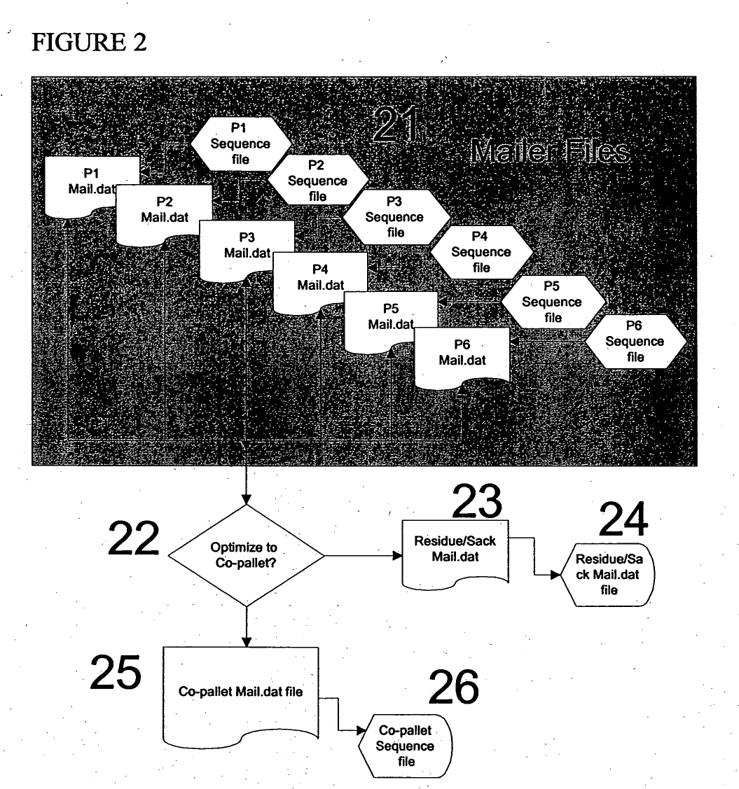

FIG. 2 is a flow chart of a typical software process, in which multiple mailing mail.dat make-up files interact with container sequence files in order to produce a co-pallet sequence file for controlling the copalletization process. The described copalletization process seeks to reduce the copalletization costs 15, in turn leading to a reduction in the postage charges 16.

A mail.dat file is a mailing standard and specification administered and provided by the International Digital Enterprise Alliance (IDE Alliance) (membership or fee required to obtain the standard specification). This specification is used by mailers and the U.S. Postal Service to communicate required information necessary for determining the makeup of a particular mailing and, ultimately, what the required postage payment should be for a specific mailing. The mail.dat specification does not require any additional information regarding the sequence of mail items in the mailing since this is not a parameter that affects postage payment. It will be appreciated that, while the U.S. Postal System mailing standards and specifications are referred to herein, the invention is not limited in this regard, and may be applicable to other mailing and package sorting standards and systems.

Item 21 illustrates how a plurality of mailings P1-P6 are created separately, each with a unique container sequence file that describes how bundles are loaded onto a container such as a pallet. A separate container sequence file may be used for creating each mailing mail.dat make-up container file, using the mail.dat or other suitable mailing standard specification. It will be appreciated that the mail.dat specification used herein is exemplary only, and that the mail make-up file may be a mail.dat file, a database file, an XML document or any other electronically generated and formatted file.

The mailing mail.dat make-up files are merged together at step 22 using software algorithms and are evaluated to determine the optimized makeup of each future mailing co-pallet mail.dat make-up file 25 the containers to be used, and the associated container sequence file 26 for the merged mailing. The co-pallet mailing mail.dat make-up file 25 forms a primary mailing mail.dat make-up file that will represent the merged mailing that is to be palletized. A secondary residual mailing make-up file 23 may also be generated. The secondary mailing make-up file 23 may or may not be used to generate a mailing of sacked containers, if there is enough mail volume remaining after palletization for the mail bundles to be grouped into sacks. An associated sequence file 24 may be generated for the residual mailing make-up file 23.

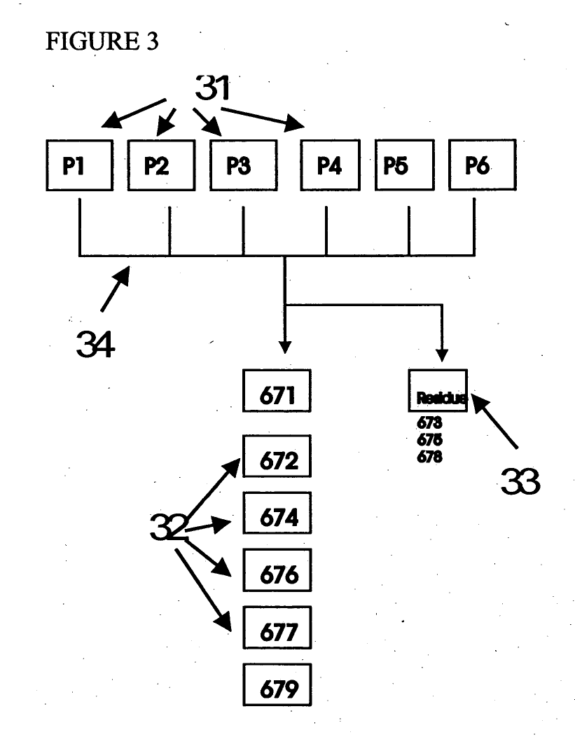

FIG. 3 illustrates an example physical process of combining multiple mailings 31 using the software sequence of FIG. 2, whereby each individual mailing, P1 through P6, is assembled in a predetermined sequence. These individual mailings are merged together in a predetermined sequence to arrive at a grouping of pallets for specific SCF's, together with residual bundles. In this example, P1 through P6 are individual mailings, each with mail for SCF's 671 through 679, representing all 5 digit ZIP codes between 67101 through 67999. The bundles pass a scan point 34 in sequence and are selectively merged onto specific output pallets 32 in sequence, or into a residue container 32, also in sequence. The scan point 34 reads the sequence of bundles to create container sequence files, which are then merged with the mail.dat files to create mailing make-up files 25 as described with reference to FIG. 2. In this example, the optimized mailing mail.dat make-up files 25 determine there was sufficient volume and cost consideration to create 6 SCF pallets representing by SCF 671, 672, 674, 676, 677, and 679. Bundles for SCF 673, 675 and 678 were diverted to the residual container, in sequence, for later processing.

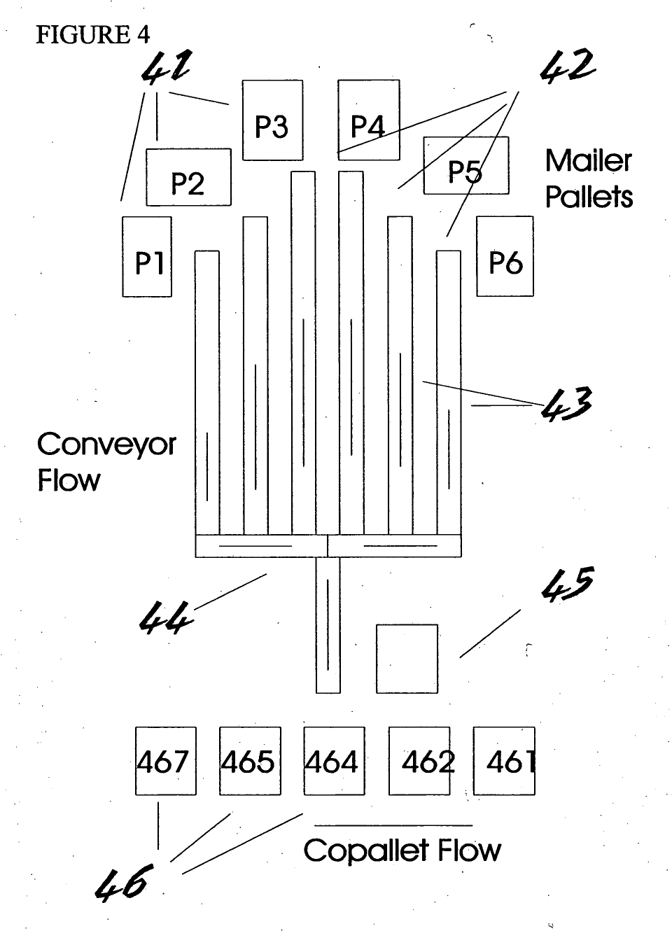

FIG. 4 illustrates a plan view of a typical mechanized conveyor layout for copalletization. Individual containers P1 through P6 as represented by 41 are assembled at the induction point 42 for each conveyor. Bundles from the containers are transferred onto a conveyor system 43, 44 where individual tracking may be performed. The bundles may be scanned to determine the bundle identity for tracking purposes, which may be performed with automated optical sensors, one or more photocells, or may be manually read using a hand-held scanner or any other suitable means and entered into a computer, based on the level of automation selected. The bundles are conveyed to the end of each individual conveyor 43 where they may be held before being released in sequence to the merge conveyor 44 according to the merged mailing mail.dat make-up file and the residual mailing mail.dat make-up file. The sequenced bundles are then loaded onto the SCF pallets 46 or the residual container 45, in sequence, based on the mailing mail.dat make-up files generated by the software.

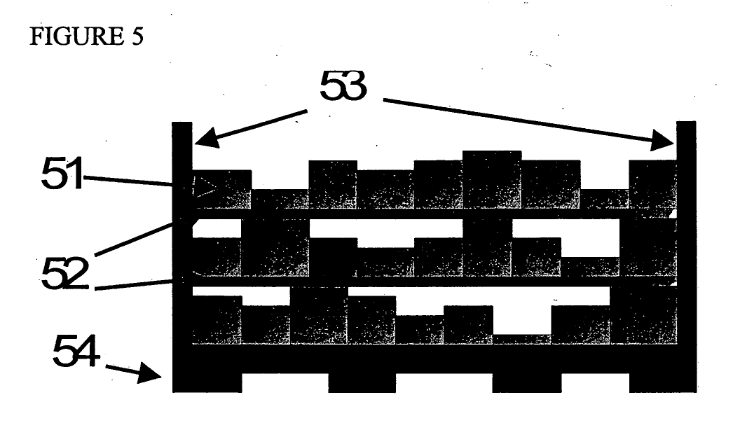

FIG. 5 illustrates a typical pallet layout created by the copalletization method described, with bundles 51 stacked on a pallet base 54. Separator sheets 52 may be included to clearly identify the levels and ensure that the proper bundle sequence is maintained. The separator sheets 52 may be cardboard or thin plastic sheeting or any suitable material, which can improve the stability and integrity of the pallet load, as well as aiding identification of the levels. A pallet skirt 53 may surround the bundles on the pallet. The pallet skirt 53 may be, in one embodiment, made of cardboard and may be used beneficially to ensure the integrity of the load and assist with stacking of pallets.

In the drawings and specification, a typical selected embodiment of the invention has been disclosed, and although specific terms are employed, the terms are used in a descriptive sense only and not for purposes of limitation. The invention has been described in considerable detail with specific reference to the illustrated embodiment. It will be apparent, however, that various modifications and changes may be made within the spirit and scope of the invention as described in the foregoing specification and as defined in the appended claims.

1. A method for determining an optimum merged mailing comprising:
evaluating a plurality of bundles of mailings; and
merging one or more of the bundles of mailings into at least one merged mailing,
wherein each of the plurality of bundles of mailings is evaluated in regards to at least one evaluation characteristic to determine an optimal combination of bundles of mailings such that the merged mailing has an optimal value for the at least one evaluation characteristic.

2. The method of claim 1, wherein the at least one evaluation characteristic is selected from at least one of a cost of mailer preparation, a cost of merging the plurality of bundles, a transportation cost, a postage cost, and a combination thereof.

3. The method claim 1, wherein multiple mailings with sequenced bundles are merged into one mailing of sequenced bundles using a system selected from a manual system and an automatic system;
further wherein the multiple mailings include any required documentation for postal service verification.

4. The method of claim 1, wherein any non-qualifying mail is diverted to a secondary location.

5. The method of claim 1, further comprising creating a mailing make-up file that describes the at least one evaluation characteristic of the at least one merged mailing.

6. The method of claim 5, wherein the merged mailing make-up file is evaluated and adjusted to ensure optimum postage discounts as a result of the merged mailing.

7. An apparatus for determining an optimum merged mailing comprising:
means for evaluating a plurality of bundles of mailings; and
means for merging one or more of the bundles of mailings into at least one merged mailing,
wherein each of the plurality of bundles of mailings is evaluated in regards to at least one evaluation characteristic to determine an optimal combination of bundles of mailings such that the merged mailing has an optimal value for the at least one evaluation characteristic.

8. The apparatus of claim 7, further comprising a separation sheet for separating layers of bundles to ensure a sequence is maintained for all levels.

9. The apparatus of claim 7, further comprising a collapsible, heavy duty, skirt for separating and stacking pallets.

10. The apparatus of claim 9, wherein the skirt is constructed out of cardboard.

11. The apparatus of claim 7, further comprising means for transporting and conveying individual bundles from an individual mailing, in sequence, to a location where all bundles are merged together on a single transport for loading onto a merged pallet or a residual bundle container.

12. The apparatus of claim 11, further comprising means for scanning bundles as they are inducted from the pallet or the residual bundle container.

13. The apparatus of claim 11, further comprising means for weighing bundles as they are inducted from the pallet or the residual bundle container.

14. The apparatus of claim 11, further comprising means for tracking bundles on a conveyor, wherein the means are selected from a photocell, an optical scanner or zone control.
